(19) United States
(12) Patent Application Publication
(10) Pub. No.: US 2016/0279536 A1
(43) Pub. Date: Sep. 29, 2016

(54) LIQUID-LIQUID EXTRACTION PROCESS AND APPARATUS

(71) Applicant: Jeffrey A. CORKERN, Baton Rouge, LA (US)

(72) Inventors: Jeffrey A. CORKERN, Baton Rouge, LA (US); Cecil E. CORKERN, Jackson, MS (US)

(21) Appl. No.: 15/178,806

(22) Filed: Jun. 10, 2016

Related U.S. Application Data
(62) Division of application No. 14/349,504, filed on Apr. 3, 2014, now abandoned.
(60) Provisional application No. 61/544,040, filed on Oct. 6, 2011.

(51) Int. Cl. B01D 11/04

(52) U.S. Cl. CPC B01D 11/0457; B01D 11/0492

(57) ABSTRACT

This invention provides processes for extracting organic compounds from aqueous samples by using relatively small amounts of extraction solvent and of the aqueous sample to be extracted. This is accomplished by increasing the surface area of the extraction solvent while preventing evaporation of the extraction solvent, which allows for greater extraction efficiency. There is little or no restriction on the aqueous sample types from which organic compounds can be extracted with the processes of this invention. An apparatus that can be employed in these processes is also provided

### CROSS-REFERENCE TO RELATED APPLICATIONS

This application is a divisional under 35 U.S.C. §121 of, and claims priority under 35 U.S.C. §120, to U.S. patent application Ser. No. 14/349,504, filed on Apr. 3, 2014, which is the National Stage filing under 35 U.S.C. §371 of PCT Patent Application Serial No. PCT/US2012/058790, filed Oct. 4, 2012, which, in turn, claims benefit of U.S. Provisional Patent Application Ser. No. 61/544,040, filed Oct. 6, 2011. The disclosures of the US patent application and the PCT Patent Application are hereby incorporated by reference in their entireties.

### TECHNICAL FIELD

This invention relates to extraction chemistry, more particularly to the extraction of organic compounds from aqueous solutions.

### BACKGROUND

There are two general techniques that are most often used for extracting organic compounds from water for analysis. These two most common techniques are widely used for two reasons. First, these two techniques give the best possible results in a Minimum Detection Limits test. Second, there is very little restriction as to the types of aqueous samples that can be successfully run with these two techniques. There are other less-common techniques for extracting organic compounds from water, most notably solid-phase extraction, but these less-common techniques all suffer from a restriction of aqueous sample types to which each is applicable and from larger Minimum Detection Limits due to restrictions on sample sizes.

Throughout this document, “Minimum Detection Limits” are defined by the procedure described in 40 C.F.R. Part 136, Appendix B, rev. 1.11 (1996), where Minimum Detection Limits are defined as the minimum concentration of a substance that can be measured and reported with 99% confidence that the analyte concentration is greater than zero, and is determined from analysis of a sample in a given matrix containing the analyte.

One of the two most-common techniques referred to above involves, on a one-liter scale, pouring approximately 1 liter of an appropriately prepared aqueous sample and a quantity of a water-immiscible extraction solvent into a separatory funnel and shaking the funnel for a brief period of time. The extraction solvent may be more dense or less dense than water. If an emulsion does not form, the mixture in the separatory funnel is allowed to settle and the organic phase is decanted. This procedure is performed twice more, and the collected organic phases are added together. After all of the organic phases are collected and combined, the combined organic phase is significantly reduced in volume, normally to 1 milliliter, for analysis. The total time for this entire extraction process is around four hours, and total (water-immiscible) extraction solvent volumes used are typically on the order of 200 to 300 milliliters per liter of aqueous sample.

The second general technique involves, on a one-liter scale, pouring approximately 1 liter of an appropriately prepared aqueous sample and a quantity, generally around 300 milliliters, of an extraction solvent, which is a water-immiscible or slightly water-immiscible solvent of higher density than the aqueous sample, into a continuous extractor. Another portion of extraction solvent is poured into a round-bottom flask and the flask is attached to the continuous extractor. A cooling column is attached to the continuous extractor and the round-bottom flask is heated sufficient to boil the extraction solvent. The extraction solvent vapor condenses in the cooling column. Drops of condensed extraction solvent fall out of the condensing (cooling) column and through the aqueous sample, extracting organic compounds, and collect in a pool at the bottom of the extractor. The continuous extractor bottom has a small glass tube through which the extraction solvent returns to the round-bottom flask, where the extraction solvent is boiled again, leaving the higher-boiling extractable organics behind. Over time, the extractable organics are removed from the water and concentrated in the organic phase in the round-bottom flask. After a period of time, on the order of 24 to 48 hours, the boiling is stopped, and all of the extraction solvent is collected and combined in the round-bottom flask. The extraction solvent in the round-bottom flask is then reduced to a small volume, normally 1 milliliter, for analysis. The total time for this extraction process is around 28 to 52 hours, and total extraction solvent volumes are around 500 to 750 milliliters.

The two most common techniques have some shortcomings. They both require relatively large volumes of costly extraction solvent(s) and large sample sizes, take a relatively long time to complete, involve a great deal of labor cost, and require the use of expensive, highly specialized glassware.

### SUMMARY OF THE INVENTION

This invention provides a process for the extraction of organic compounds from aqueous solutions, and an apparatus for extracting organic compounds from aqueous solutions. More generally, the present invention can be applied for mass transfer between any two immiscible or slightly immiscible liquids. The processes of this invention are applicable to the field of analytical chemistry, and in particular, to the field of environmental analytical chemistry, especially for use in extracting organic chemicals from aqueous samples. Advantages provided by the present invention include, without limitation, shorter total extraction times and improved Minimum Detection Limits values, while also lowering both material costs and labor costs.

An embodiment of this invention is a process for separation of at least one extractable organic compound from an aqueous sample. The process comprises bringing together an extraction solvent and an aqueous sample containing one or more extractable organic compounds to form a mixture. The mixture is in a container (sometimes referred to herein as a sample cup), and the container is sealed to minimize or prevent evaporation. Then the mixture is stirred at a rate sufficient to increase the surface area of the extraction solvent. The stirring is then stopped, and the mixture is allowed to separate into phases, and separating the phases formed, to obtain at least a separated organic phase.

Another embodiment of this invention is an apparatus for separation of at least one extractable organic compound from an aqueous sample. The apparatus comprises a container, a conduit, a valve, an external cap, and a stirring paddle. The container has interior walls, a top, and a bottom, and the container is shaped and configured to define a first opening at the top and a second opening at the bottom opposite to the first opening. The conduit is sealably connected to the second opening of the container, and the conduit is configured to accept a valve that controls fluid passage through the conduit; the valve controls fluid passage through the conduit. The external cap is sized and configured to sealably connect to the first opening of the container, and the external cap further defines a sealable opening that can sealably accept a rod through the external cap. The stirring paddle comprises a rod and at least one flange, the rod extending through the external cap.

These and other embodiments and features of this invention will be still further apparent from the ensuing description, drawings, and appended claims.

### BRIEF DESCRIPTION OF THE DRAWINGS

FIG. 1 shows a preferred external evaporation-inhibition cap for use in this invention.

FIG. 2 shows a preferred apparatus of this invention.

FIG. 3 is a front view of a preferred apparatus of this invention.

FIG. 4 is a side view of a preferred apparatus of this invention.

### FURTHER DETAILED DESCRIPTION OF THE INVENTION

As used throughout this document, the term “organics” is used as a shortened form for “organic compounds.”

References in this document to 40 C.F.R., whether Part 136, Appendix B, rev. 1.11 (1996) or Part 136 Appendix A (1996), are to the United States Code of Federal Regulations, in particular to the portion of the Code of Federal Regulations in which the U.S. Environmental Protection Agency sets forth its rules.

Appropriate sample preparation may include, but is not limited to, adding sodium chloride or other chemicals or reagents, and/or raising or lowering the sample pH. As an example, for Method 608 pesticides (see 40 C.F.R. Part 136 Appendix A, 1996), add 18 grams of sodium chloride per 100 milliliters of sample. Appropriate sample preparation may also include addition of surrogate compounds, defined as compounds representative of the compound class or classes to be extracted. The purpose of adding surrogate compounds is to estimate the efficiency of extraction of the compound class or classes to be extracted from the particular sample under analysis. For example, a fifty percent surrogate recovery for a particular sample suggests fifty percent of the compound class or classes present were extracted from that particular sample.

Extraction solvents are organic solvents that are slightly immiscible to immiscible with water, and may be denser or less dense than the aqueous sample. The degree of water miscibility that is acceptable varies with the nature of the organics to be extracted from the aqueous sample. The extraction solvent may be one organic solvent, or a mixture of two or more organic solvents, so long as all of the solvents in the mixture are at least slightly immiscible with water. Extraction solvents are used in appropriate amounts relative to the aqueous sample. For example, in the specific case of certain pesticides (40 C.F.R. Part 136 Appendix A, Method 608), add 5 milliliters dichloromethane per 100 mL of aqueous sample. Note that 5 mL of dichloromethane per 100 mL of aqueous sample is 5 volume % of extraction solvent per aqueous sample. This compares favorably to the first method described in the Background section above, in which the extraction solvent is 20 to 30 volume percent of the aqueous sample.

Appropriate sample amount will depend on sample cup size. Sample preparation and contact with the extraction solvent can occur before or after the aqueous sample has been introduced into the sample cup. After sample preparation, the aqueous sample is stirred at low (conventional) stirring speeds to distribute all of the chemicals evenly. Preferably, sample preparation is performed before the aqueous sample is introduced into the sample cup. Also preferred is to introduce both the aqueous sample and the extraction solvent into the sample cup, although pre-mixing of the aqueous sample and the extraction solvent is acceptable.

The surfaces of equipment that come into contact with the mixture or components thereof are inert to the mixture and/or components thereof to prevent surface adsorption of trace-level organics. As used throughout this document, the term “inert” means non-adsorptive and non-reactive to all chemicals present in the mixture. To be inert, the surfaces of equipment that come into contact with the mixture or components thereof are either composed of an inert, non-adsorptive substance, such as borosilicate glass or polytetrafluoroethylene, or coated with an inert, non-adsorptive substance. The mixture is formed from, and typically contains, an aqueous sample, an extraction solvent, sample preparation chemicals (appropriate chemicals), and optionally surrogate compounds. Equipment that comes into contact with the mixture or components thereof usually includes at least the container (sample cup), stirring paddle, and the external evaporation-inhibition cap.

Extraction speed and efficiency is a function of total extraction solvent surface area. The larger the total solvent surface area, the faster and more efficient the extraction. The processes of present invention generates much larger extraction solvent surface area than the current methods described in the Background section, and transfer of the organics to the organic phase is therefore greatly accelerated. Advantageously, the large surface area provided by the processes of the present invention are easily generated, and do not require expensive machinery or instrumentation.

The larger surface area of extraction solvent in the processes of this invention is provided by formation of small droplets of the extraction solvent in the mixture. In this invention, small droplets are normally generated by rapid stirring of the sample. While other stirring mechanisms can be employed, stirring paddles driven by motors allow the desired stirring rates to be achieved more easily. With a stirring paddle, small droplets are generated by having a total stirring paddle area that is relatively small as compared to normal mechanical stirring rods, and by stirring at relatively higher stirring speeds.

The sample cup is sealed to reduce the volume over the extraction mixture, preferably to as close to zero as possible, to minimize or prevent evaporation of the extraction solvent. To further reduce the volume in the sample cup over the extraction mixture, use of an internal evaporation-inhibition cap is recommended and preferred. The internal evaporation-inhibition cap is designed to fit inside the sample cup, and preferably to seal to the interior surface of the sample cup and to the surface of the rod of the stirring paddle. The internal evaporation-inhibition cap is intended to sit slightly above, or preferably at, the top of the extraction mixture. Sealing the sample cup is a feature of the processes of this invention because the small droplets formed have a high surface area, which in turn causes the extraction solvent to evaporate quickly in the absence of such sealing.

Stirring paddles in the practice of this invention are of such a design as to generate high extraction solvent surface area by rendering extraction solvent into very small droplets while simultaneously having only a minimal stirring action on the sample. Stirring paddle design may vary depending on the sample preparation and the particular extraction solvent used.

One effective and preferred stirring paddle design consists of one or more, preferably one, small triangular flanges (or “wings”) of an inert, non-adsorptive substance attached to the side of the stirring rod at the stirring rod's lowest point. The base of the solid triangle is level with the stirring rod bottom, with the triangle's tip pointing upward. The small contact surface area of this design generates small droplets, which get smaller as stirring speed and therefore impact energy increase. The tilted flat surface of the solid triangular flange is designed to throw droplets off at high speed up against a downward water flow, creating a shearing action to help generate small droplets. FIG. 2 shows an apparatus 1 which contains a representation of this preferred stirring paddle with one solid triangular flange. In FIG. 2, stirring paddle 20 has a rod 21 and a solid triangular flange 23.

Stirring speeds (sometimes referred to herein as the “stirring rod rate”) must be low enough to avoid cavitating the extraction solvent and introducing emulsion-forming gas bubbles into the sample. Thus, the term “minimal stirring” as used throughout this document refers to the concept that stirring should not be so fast or violent as to cause introduction of air (gas) bubbles into the sample, which can thereby possibly form an emulsion.

Stirring speeds and stirring times will vary depending on the organic compound class or classes to be extracted. Generally, stirring speeds will be on the order of about 1000 to about 6000 RPM (revolutions per minute). Preferred stirring speeds are in the range of about 3000 to about 5000 RPM. Stirring times will typically be on the order of about one to about twenty minutes at the 100-mL scale. For example, in the specific case of pesticides (40 C.F.R. Part 136 Appendix A Method 608), stirring for 5 minutes is usually sufficient for a 100-mL sample, at stirring speeds in the range of about 3500 to about 4500 RPM, more preferably at about 4000 RPM or about 4500 RPM.

After stirring the mixture at the selected stirring speed(s) for an appropriate amount of time, stirring is stopped, and the mixture is allowed to settle for an appropriate amount of time to form separate phases. For example, in the specific case of certain pesticides (40 C.F.R. Part 136 Appendix A, Method 608) the mixture is allowed to settle for 5 minutes for phase separation of a 100-mL sample. The phases formed are separated, to obtain a separated organic phase. The organic compounds are in the organic phase, which comprises at least a portion of the extraction solvent.

Total extraction times will generally be around an hour, depending on the compound class or classes to be extracted. For example, in the specific case of certain pesticides (40 C.F.R. Part 136 Appendix A Method 608), total extraction time is around 45 minutes. This compares favorably with 240 minutes (4 hours) for separatory-funnel extraction, and with 1440 to 2880 minutes (24 to 48 hours) for continuous extraction.

The extraction procedure may be repeated if necessary, depending on the compound class or classes to be extracted. As an example, for the specific case of certain pesticides (40 C.F.R. Part 136 Appendix A Method 608), the extraction procedure is repeated twice more.

If desired, the extracts (separated organic phases) are combined for concentration and analysis.

As mentioned above, another embodiment of this invention is an apparatus which comprises a container, a conduit, a valve, an external cap, and a stirring paddle. The container (sample cup) has interior walls, a top, and a bottom, and the container is shaped and configured to define a first opening at the top (the open top) and a second opening at the bottom opposite to the first opening. The conduit (tube) is sealably connected to the second opening of the container, and the conduit is configured to accept a valve that controls fluid passage through the conduit; the valve (usually a stopcock) controls fluid passage through the conduit. The external (evaporation-inhibition) cap is sized and configured to sealably connect to the first opening (top) of the container, and the cap further defines a sealable opening that can sealably accept a rod through the external cap. The stirring paddle comprises a rod and at least one flange, the rod of the stirring paddle extending through the external cap.

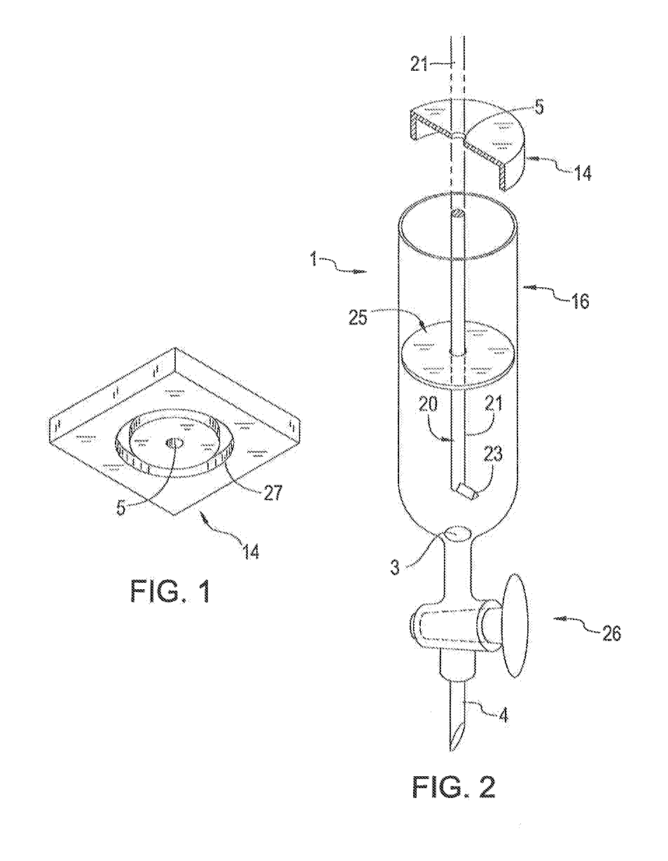

Referring now to the Figures, FIG. 1 shows a view of the underside of a preferred external cap 14, which has an opening 5 and a groove 27. Groove 27 is configured to fit around first opening 2 at the top of sample cup 16 such that external cap 14 extends around both the outside and inside of the sample cup 16 at first opening 2.

FIG. 2 shows a view of a preferred apparatus 1 of the present invention. Sample cup 16 has a first opening 2 at the top, a second opening 3 at the bottom, and conduit 4 extending from second opening 3. Valve 26 in conduit 4 is a stopcock. External evaporation-inhibition cap 14 has an opening 5 through which rod 21 of the stiffing paddle 20 extends. Stirring paddle 20 has rod 21 and a solid triangular flange 23, which is a preferred flange in the practice of this invention. Also shown is an internal evaporation-inhibition cap 25, designed to fit inside sample cup 16, and to seal to the interior surface of sample cup 16 and to the surface of stirring rod 21.

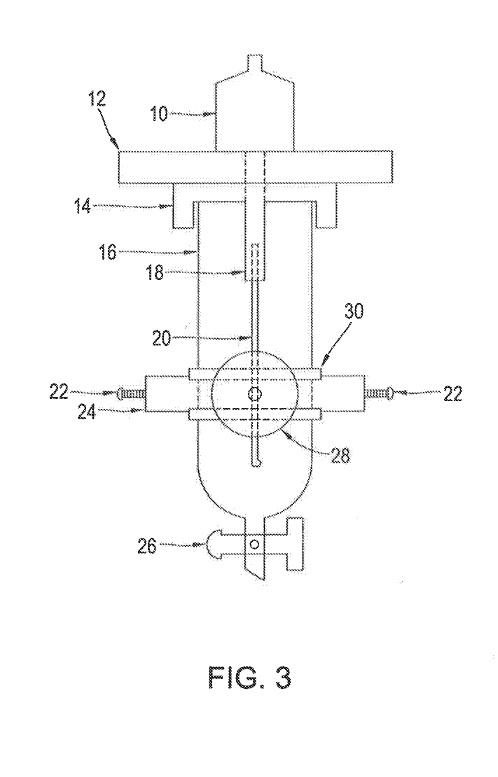

FIG. 3 shows a front view of a preferred apparatus 1 of the invention. Stirring motor 10 is attached to the top of stiffing motor mounting plate 12. External evaporation-inhibition cap 14 is attached to the underside of stiffing motor mounting plate 12. Cap 14 completely encloses the first opening at the top of sample cup 16. Sample cup 16 is shown in position, with stiffing motor adapter 18 holding stirring paddle 20 from the top part of the rod 21. In FIG. 3, the apparatus 1 is on a mount, portions of which are shown. Sample cup 16 is sitting in sample cup holder 24, which is held in place by ring 30, and locked in position by springs 34 (not shown in FIG. 3) attached to spring mounts 22. Sample cup holder 24 is opened and closed by turning cup-release wheel 28. After extraction and phase separation, samples are drained from stopcock 26.

In preferred way of mounting the apparatus (not shown), the sample cup holder is one piece. This one-piece sample cup holder is shaped to fit the exterior of the sample cup so that the sample cup sits upright in the holder without additional support. For example, a ring or incomplete ring with internal curvature conforming to the shape of the outside of the sample cup may be used.

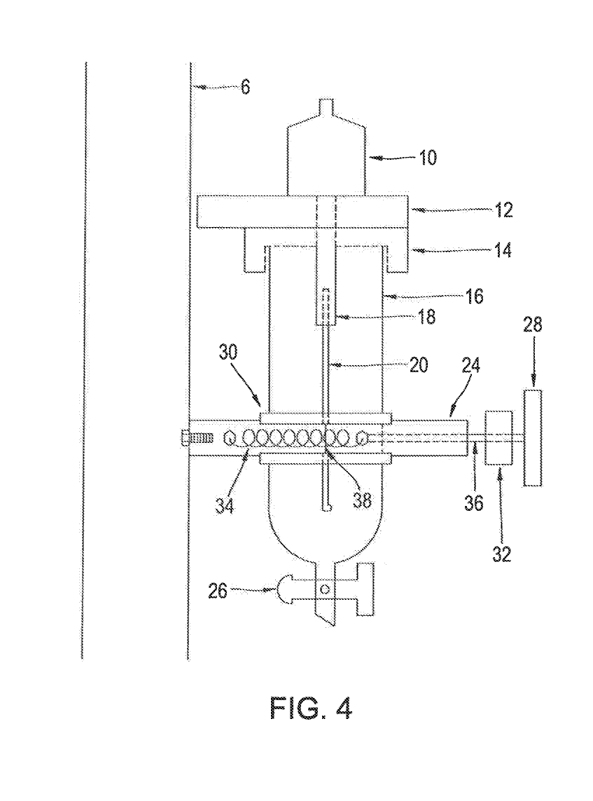

FIG. 4 shows a side view of a preferred apparatus 1 of the invention attached to a mount 6. This side view of the apparatus 1 exposes spring 34, split 38, holding rack bars 36, and force-distribution bar 32. The apparatus 1 is attached to mount 6 by spring mounts 22 and springs 34, which connect ring 30, on which apparatus 1 sits, to the mount 6.

To use the apparatus 1 shown in FIGS. 3 and 4, grasp the bottom of sample cup 16 with one hand. Turn cup-release wheel 28 with other hand. The front half of sample cup holder 24 separates along split 38 and moves along holding rack bars 36 toward the user, releasing sample cup 16. Gently slide sample cup 16 down until it is free of sample cup holder 24, being careful not to contact stirring paddle 20. When the apparatus is mounted in a one-piece sample cup holder, the sample cup is removed from the holder merely by lifting the sample cup out of the holder, being careful not to contact the stirring paddle.

Once sample cup 16 is free, add the appropriate amount of appropriately prepared aqueous sample and the extraction solvent to sample cup 16. Place sample cup 16 (now containing the appropriately prepared aqueous sample and the extraction solvent) back into sample cup holder 24 and push top of sample cup 16 firmly against external evaporation-inhibition cap 14 to seal. Turn cup-release wheel 28 so springs 34 pull front half of sample cup holder 24 back tight against sample cup 16. For a one-piece sample cup holder, the sample cup is placed on the holder, and the top of the sample cup is pressed firmly against the external evaporation-inhibition cap to seal.

Start stirring motor 10 and spin stirring paddle 20 at appropriate stirring speed to render extraction solvent into very small droplets. After an appropriate amount of stirring time, turn stirring motor 10 off. Pull sample cup 16 down until the bottom of stirring paddle 20 is no longer in contact with the solution. This prevents extraction solvent (which may contain organics to be analyzed) from collecting on stirring paddle 20. After phases have separated, drain each separate phase through stopcock 26. The upper layer can be decanted rather than drained, but draining is preferable to avoid mixing the separated phases.

Further embodiments of the invention include, without limitation:

A) A process for the analysis of extractable organic compounds contained in an aqueous sample comprising the steps of:
i) placing an appropriate amount of an aqueous sample containing one or more extractable organic compounds into a sample cup having an opening at the top and equipped with a stirrer having a stirring paddle;
ii) appropriately preparing the sample by addition of the appropriate chemicals to the aqueous sample, depending upon the compound class or classes being extracted;
iii) optionally, adding surrogate compounds representative of the compound class or classes being extracted to the solvent-sample mixture;
iv) stirring the mix at low stiffing speed to distribute all chemicals evenly before adding extraction solvents;
v) adding an appropriate amount of an extraction solvent to the aqueous sample, said solvent being either more or less dense than the aqueous sample, and being either a water-immiscible or slightly water-miscible solvent, or a mixture of water-immiscible and/or slightly water-miscible solvents, forming a solvent-sample mixture;
vi) sealing the top of the sample cup with a cap;
vii) stirring the solvent-sample mixture with the stirring paddle to convert the extraction solvent into droplets, and allowing the organic compounds to transfer to the extraction solvent, forming an extract, collecting and removing the extract which contains extractable organic compounds; and
viii) where the surfaces of the sample cup and the stirring paddle that come into contact with the aqueous sample, extraction solvent, appropriate chemicals, and optional surrogate compounds are non-adsorptive and non-reactive to the aqueous sample, extraction solvent, appropriate chemicals, and optional surrogate compounds.

B) The process of A) wherein the section of the paddle that contacts the solution is either composed of an inert, non-adsorptive substance or coated with an inert, non-adsorptive substance.

C) The process of A) wherein the entire extraction cup is either composed of an inert, non-adsorptive substance, or coated with an inert, non-adsorptive substance, or the interior surface is coated with an inert, non-adsorptive substance.

D) The process of A) wherein the section of the paddle that contacts the solution generates a very large extraction solvent surface area by spinning at the appropriate stirring speed and generating very small droplets.

E) The process of A) wherein the stirring paddle has one or more triangular flanges.

F) The process of A) wherein the paddle stirring speed is about 3500-4500 RPM for about 100 milliliters of an aqueous sample containing about 18 grams of sodium chloride as the appropriate chemical and about 5 milliliters dichloromethane as the extraction solvent.

G) The process of D) wherein the paddle design and stirring speed are such emulsions are not formed or are minimized by spinning at low stirring speed in a manner air is not pulled into the sample and the extraction solvent does not cavitate, such as a triangular flange design spinning at 4000 RPM for 100 milliliters deionized water containing 18 grams of sodium chloride and 5 milliliters dichloromethane extraction solvent.

H) The process of D) wherein the paddle design is such it increases solvent surface area while simultaneously stirring the sample in a manner emulsions are not formed or are minimized, such as a triangular flange design spinning at 4000 RPM for 100 milliliters deionized water containing 18 grams of sodium chloride and 5 milliliters dichloromethane extraction solvent.

I) The process of D) wherein extraction solvent evaporation during stirring is inhibited by use of an evaporation-inhibition cap.

J) The process of A) further comprising analyzing at least a portion of the extract.

K) The process of A) further comprising repeating said process on another aqueous sample, and combining the extracts of said aqueous samples.

L) The process of F) wherein the stiffing paddle has one or more triangular flanges.

M) An apparatus which is a container comprised of a container surface which defines a first opening, and, opposite to the first opening, the container surface defines a second opening which is sealably connected to a conduit, which conduit is configured to accept a valve that controls fluid passage from the conduit.

N) An apparatus as in M) further comprising a surface capable of sealably connecting to said first opening, said surface defining a sealable opening that can sealably accept an object that extends through said surface.

0) An apparatus for liquid-liquid extraction which comprises:
a container comprised of a container surface which defines a first opening, and, opposite to the first opening, the container surface defines a second opening which is sealably connected to a conduit, which conduit is configured to accept a valve that controls fluid passage from the conduit;
a surface capable of sealably connecting to said first opening, said surface defining a sealable opening that can sealably accept an object that extends through said surface; and
an object that extends through said surface, wherein said object is a part of a stirring mechanism.

The present invention is not limited to the drawings, which illustrate preferred embodiments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent or other publication or published document referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

1. A process for separation of at least one extractable organic compound from an aqueous sample, which process comprises:
i) bringing together an extraction solvent and an aqueous sample containing one or more extractable organic compounds to form a mixture, wherein said mixture is in a container constructed of inert material, and sealing the container with inert material to minimize or prevent evaporation;
ii) stirring the mixture at a rate sufficient to increase the surface area of the extraction solvent; and
iii) stopping the stirring, allowing separate phases to form from the mixture, and separating the phases formed, to obtain a separated organic phase.

2. A process as in claim 1 wherein a stirring paddle is employed.

3. A process as in claim 2 wherein the stirring paddle has one or more solid triangular flanges.

4. A process as in claim 1 wherein said rate of stirring is at one or more speeds in the range of about 1000 to about 6000 revolutions per minute.

5. A process as in claim 1 wherein said rate of stirring is at one or more speeds in the range of about 3000 to about 5000 revolutions per minute.

6. A process as in claim 1 wherein said extraction solvent is dichloromethane.

7. A process as in claim 1 wherein said rate of stirring is about 3500 to about 4500 revolutions per minute for about 100 milliliters of an aqueous sample, wherein said extraction solvent is dichloromethane, wherein there are about 5 milliliters dichloromethane per about 100 milliliters of an aqueous sample, and optionally wherein said mixture also contains about 18 grams of sodium chloride.

8. A process as in claim 7 wherein said rate of stirring is about 4500 revolutions per minute.

9. A process as in claim 1 wherein said extractable organic compound belongs to at least one compound class, and wherein one or more surrogate compounds representative of said compound class is present in the mixture.

10. A process as in claim 1 further comprising repeating said process on another aqueous sample, and optionally combining at least a portion of each separated organic phase.

11. The process as in claim 1 further comprising analyzing at least a portion of the separated organic phase.
